(19) United States
(12) Patent Application Publication
(10) Pub. No.: US 2026/0221153 A1
(43) Pub. Date: Jul. 30, 2026

(54) MAGNETIC RECORDING MEDIUM AND MAGNETIC STORAGE DEVICE

(71) Applicant: Resonac Hard Disk Corporation, Chiba (JP)

(72) Inventors: Takayuki FUKUSHIMA, Chiba (JP); Lei ZHANG, Chiba (JP)

(21) Appl. No.: 19/454,906

(22) Filed: Jan. 21, 2026

(30) Foreign Application Priority Data
Jan. 27, 2025 (JP) 2025-011310

(51) Int. Cl. G11B 5/66; G11B 5/00

(52) U.S. Cl. CPC G11B 5/66; G11B 2005/0021

(57) ABSTRACT

A magnetic recording medium of a heat-assisted recording system includes a substrate; a first underlying layer; a second underlying layer; a magnetic layer; and a protective layer, which are stacked in the stated order. A thickness of the magnetic layer is within a range of 10 nm to 25 nm, the magnetic layer includes magnetic particles having an L1₀ structure, a thermal conductivity of the magnetic particles in a perpendicular direction is within a range of 10 W/(m·K) to 20 W/(m·K), a thermal conductivity of the magnetic particles in a planar direction is within a range of 1 W/(m·K) to 10 W/(m·K), and a ratio of the thermal conductivity in the perpendicular direction to the thermal conductivity in the planar direction is 2 or greater, and the magnetic layer includes, as an additive element, at least one element selected from a group consisting of Rh, Ir, Ru, and Pd.

### CROSS-REFERENCE TO RELATED APPLICATIONS

This application is based on and claims priority to Japanese Patent Application No. 2025-011310, filed on Jan. 27, 2025, the entire contents of which are incorporated herein by reference.

### FIELD

The present disclosure relates to a magnetic recording medium and a magnetic storage device.

### BACKGROUND

In recent years, assisted recording systems such as a heat-assisted recording system or a microwave-assisted recording system in which a magnetic recording medium is locally heated by radiating it with near-field light or microwaves to reduce its coercive force and record data have attracted attention as a next-generation recording system capable of implementing a high areal recording density of approximately 2T-bits/inch².

By using the magnetic head of such an assist recording system, it is possible to easily record data on a magnetic recording medium having a coercive force of several tens kOe at room temperature. As the magnetic particles contained in the magnetic layer of the magnetic recording medium, for example, magnetic particles having a high magnetocrystalline anisotropy constant (Ku) are used. The magnetic particles having a high magnetocrystalline anisotropy constant (Ku) can be miniaturized while maintaining thermal stability, thereby increasing the coercive force at room temperature.

As the magnetic particles having a high magnetocrystalline anisotropy constant (Ku), for example, magnetic particles having an L1₀ structure such as Fe—Pt alloy particles having a maximum magnetocrystalline anisotropy constant (Ku) of 7×10⁶ J/m³ and Co—Pt alloy particles having a maximum magnetocrystalline anisotropy constant (Ku) of 5×10⁶ J/m³ are known.

In the heat-assisted magnetic recording medium having two magnetic layers containing magnetic particles having a high magnetocrystalline anisotropy constant (Ku), for example, Patent Document 1 discloses that the Curie temperature of the first magnetic layer is set lower than the Curie temperature of the second magnetic layer.
Patent Document 1: Japanese Patent Application Laid-open No. 2010-108571.

### SUMMARY

A magnetic recording medium of a heat-assisted recording system, includes a substrate; a first underlying layer; a second underlying layer; a magnetic layer; and a protective layer, which are stacked in an order of the substrate followed by the first underlying layer followed by the second underlying layer followed by the magnetic layer followed by the protective layer, wherein a thickness of the magnetic layer is within a range of 10 nm to 25 nm, the magnetic layer includes magnetic particles having an L1₀ structure, a thermal conductivity of the magnetic particles in a perpendicular direction of the magnetic layer is within a range of 10 W/(m·K) to 20 W/(m·K), a thermal conductivity of the magnetic particles in a planar direction of the magnetic layer is within a range of 1 W/(m·K) to 10 W/(m·K), and a ratio of the thermal conductivity in the perpendicular direction to the thermal conductivity in the planar direction is 2 or greater, the magnetic layer includes, as an additive element, at least one element selected from a group consisting of Rh, Ir, Ru, and Pd, an additive amount of the additive element is within a range of 0.1 atom % to 2 atom % of a total amount of the magnetic layer, a content of the additive element in a region up to 2.5 nm from a surface of the magnetic layer facing the protective layer is 5 atom % or less of the total amount of the magnetic layer, a content of the additive element in a region up to 5 nm from a surface of the magnetic layer facing the second underlying layer is within a range of 50 atom % to 95 atom % of the total amount of the magnetic layer, a thickness of the first underlying layer is 10 nm or more, an average thermal conductivity in a region up to 10 nm from a surface of the first underlying layer facing the magnetic layer is 100 W/(m·K) or more, and the second underlying layer includes an ionic crystal having a thickness within a range of 0.5 nm to 15 nm.

### BRIEF DESCRIPTION OF THE DRAWINGS

FIG. 1 is a cross-sectional view illustrating an example of a layer configuration of a magnetic recording medium according to an embodiment of the present disclosure;

FIG. 2 is a perspective view illustrating an example of a magnetic storage device according to an embodiment of the present disclosure; and

FIG. 3 is a schematic view illustrating the magnetic head of FIG. 2.

### DESCRIPTION OF THE EMBODIMENTS

In a magnetic recording medium of a heat-assisted recording system (hereinafter, it may be simply referred to as “heat-assisted magnetic recording medium”), recording is performed by locally heating a magnetic layer by using near-field light emitted from a laser or the like to reduce the coercive force of the magnetic layer. At this time, the heat of the laser beam diffuses to the surroundings during heating, and, therefore, a temperature difference occurs in the depth direction of the magnetic layer. This temperature difference causes a disturbance in the rotation of magnetic spins in the depth direction of the magnetic layer, resulting in degrading of the electromagnetic conversion characteristics of the heat-assisted magnetic recording medium.

Further, in order to increase the areal recording density of the heat-assisted magnetic recording medium, the magnetic layer is to be thicker in order to secure the volume of the magnetic material constituting one bit, and, therefore, degrading of the electromagnetic conversion characteristics of the heat-assisted magnetic recording medium becomes more prominent.

An object of an aspect of the present disclosure is to provide a magnetic recording medium that can improve electromagnetic conversion characteristics even when used in a heat-assisted recording system.

Embodiments of the present disclosure will be described below with reference to the drawings. In the drawings used in the following description, characteristic parts may be enlarged for convenience in order to make the characteristics easy to understand, and the dimensional ratio of the respective components may not be the same. In this specification, “to” indicating a numerical range means that the numerical values before and after the numerical range are included as a lower limit value and an upper limit value unless otherwise specified. In the numerical range indicated by “to”, when only the upper limit value is indicated in units, the lower limit value also means to have the same unit.

### [Magnetic Recording Medium]

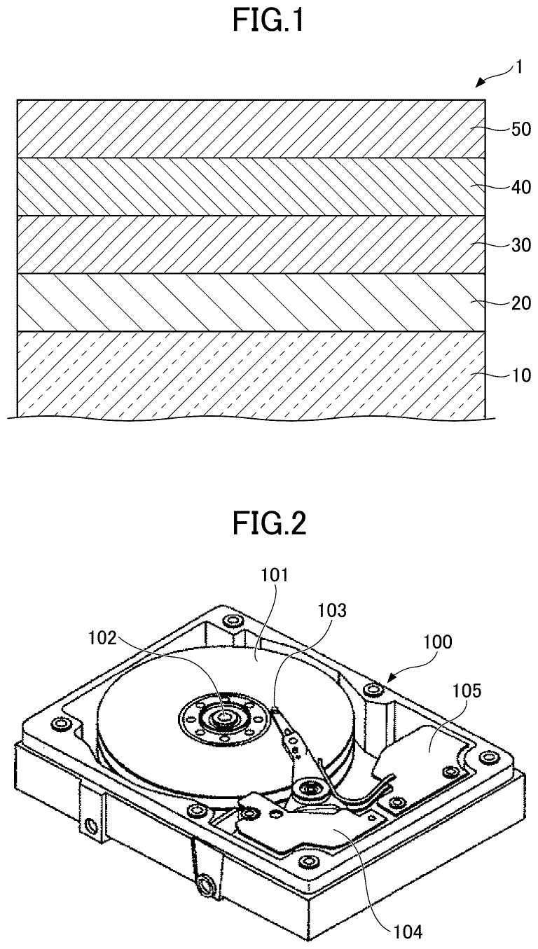

FIG. 1 illustrates an example of a layer configuration of a magnetic recording medium according to an embodiment of the present disclosure (hereinafter, it may be simply referred to as “the present embodiment”). As illustrated in FIG. 1, a magnetic recording medium 1 according to the present embodiment is an assist recording type magnetic recording medium having a substrate 10, a first underlying layer 20, a second underlying layer 30, a magnetic layer 40, and a protective layer 50 stacked in this order.

In the magnetic recording medium 1, the thickness of the magnetic layer 40 is within a range of 10 to 25 nm, and the magnetic layer 40 includes magnetic particles having an L1₀ structure. The thermal conductivity of the magnetic particles included in the magnetic layer 40 in the perpendicular direction is within a range of 10 to 20 W/(m·K), the thermal conductivity in the planar direction is within a range of 1 to 10 W/(m·K), and the ratio (anisotropy) of the thermal conductivity in the perpendicular direction to the thermal conductivity in the planar direction is 2 or greater. The magnetic layer 40 contains at least one element selected from the group consisting of Rh, Ir, Ru, and Pd as an additive element, and the additive amount of the additive element is within the range of 0.1 to 2 atom % (atom % means “at %”) of the entire magnetic layer 40. The content of the additive element in a region up to 2.5 nm from the surface of the magnetic layer 40 facing the protective layer 50 is 5 atom % or less of the entire magnetic layer 40, and the content of the additive element in a region up to 5 nm from the surface of the magnetic layer 40 facing the second underlying layer 30 is within the range of 50 to 95 atom % of the entire magnetic layer 40. Further, the thickness of the first underlying layer 20 is 10 nm or more, the average thermal conductivity of the first underlying layer 20 in a region having a thickness of 10 nm on the magnetic layer 40 side is 100 W/(m·K) or more, and the second underlying layer 30 contains an ionic crystal having a thickness within the range of 0.5 to 15 nm.

The magnetic recording medium 1 can be improved in electromagnetic conversion characteristics even when it is used in a heat-assisted recording system by having the above-described configuration. Thus, the areal recording density of the magnetic recording medium 1 can be further improved.

Further, the magnetic recording medium 1 can be improved in electromagnetic conversion characteristics by suppressing degrading in electromagnetic conversion characteristics even when the magnetic layer 40 is thickened by having the above-described configuration.

The electromagnetic conversion characteristics (SNR) can be measured by using a general measurement method such as a spin stand made by Guzik, for example.

The magnetic recording medium 1 will be described in detail.

As described above, in general, in a thermally assisted magnetic recording medium, the magnetic layer is locally heated by using near-field light emitted from a laser or the like to reduce the coercive force of the magnetic layer to perform recording. However, because the heating ability of the near-field light is attenuated in the depth direction of the magnetic layer, a temperature difference occurs in the depth direction of the magnetic layer. This temperature difference causes disturbance of the rotation of the magnetic spin in the depth direction of the magnetic layer.

The present inventors studied conditions under which disturbance of the rotation of the magnetic spin in the depth direction of the magnetic layer is not caused during laser heating by experiments and calculations. As a result, the present inventors found the following points.

First, when the magnetic layer 40 is heated at a maximum temperature of 650 K, the magnetic layer 40 is designed so that the temperature difference between the highest-temperature section and the lowest-temperature section of the magnetic layer 40 is within the range of 50 to 150 K, and the interfacial thermal resistance between the first underlying layer 20 and the second underlying layer 30 is within the range of 1×10⁻¹⁰ to 1×10⁻⁸ (m²K)/W. Second, in order for the magnetic layer 40, the first underlying layer 20, and the second underlying layer 30 to implement the structure described above in the first point, the thickness of the magnetic layer 40 is within the range of 10 to 25 nm, the thermal conductivity of the magnetic particles contained in the magnetic layer 40 in the perpendicular direction is within the range of 10 to 20 W/(m·K), and the thermal conductivity in the planar direction is within the range of 1 to 10 W/(m·K). The ratio (anisotropy) of the thermal conductivity of the magnetic particles in the perpendicular direction to the thermal conductivity in the planar direction is 2 or greater. Further, the thickness of the first underlying layer 20 is 10 nm or more, and the average thermal conductivity in the region of 10 nm thickness on the magnetic layer 40 side is 100 W/(m·K) or more. The second underlying layer 30 is configured to contain an ionic crystal having a thickness within the range of 0.5 to 15 nm.

Further, the present inventors have focused on the fact that Rh, Ir, Ru, and Pd can be used as additive elements effective in lowering the Curie temperature of the magnetic layer 40. These additive elements are added within a range of 0.1 to 2 atom % of the entire magnetic layer. The content of the additive elements in a region up to 2.5 nm from the surface (that is, the surface of the magnetic layer 40 on the side of the protective layer 50, which is the upper surface of the magnetic layer 40 in FIG. 1) of the magnetic layer 40 facing the protective layer 50, is set to 5 atom % or less of the entire magnetic layer 40. The content of the additive elements in a region up to 5 nm from the surface (that is, the surface of the magnetic layer 40 on the side of the second underlying layer 30, which is the lower surface of the magnetic layer 40 in FIG. 1) of the magnetic layer 40 facing the second underlying layer 30, is set to 50 to 95 atom % of the entire magnetic layer 40. Thus, it has been found that even when the magnetic layer 40 is thickened, the magnetic recording medium 1 in which the disturbance of the rotation of the magnetic spin in the depth direction of the magnetic layer 40 is reduced during laser heating, can be obtained.

For example, when 0.1 to 2 atom % of Rh is added as an additive element to the entire magnetic layer 40, 5 atom % or less of Rh, for example, 0.005 to 0.1 atom % or less of Rh in the entire magnetic layer 40 is contained in a region up to 2.5 nm from the surface where the magnetic layer 40 faces the protective layer 50. Within a range of 50 to 95 atom % of the entire magnetic layer, for example, 0.05 to 1.9 atom % of Rh is contained in a region up to 5 nm from the surface where the magnetic layer 40 faces the second underlying layer 30. The remaining Rh is contained in other regions (that is, the region excluding the region up to 2.5 nm from the surface where the magnetic layer 40 faces the protective layer 50 and the region up to 5 nm from the surface where the magnetic layer 40 faces the second underlying layer 30) of the magnetic layer 40.

Here, when magnetic particles having an L1₀ structure are used for the magnetic layer 40, according to the study by the present inventors, the amount of change in the Curie temperature when Rh or Ir is contained in the magnetic layer 40 is approximately 10 K/atom %. The amount of change in the Curie temperature when Ru is contained in the magnetic layer 40 is approximately 12 K/atom %. The amount of change in the Curie temperature when Pd is contained in the magnetic layer 40 is approximately 3.7 K/atom %.

In the above example in which 0.1 to 2 atom % of Rh is added to the entire magnetic layer 40, the gradient of the Curie temperature in the depth direction of the magnetic layer 40 is within the range of 0.05 to 1 K/nm, which is a suitable gradient for the Curie temperature of the magnetic particles having the L1₀ structure included in the magnetic layer 40. For example, when the magnetic particles having the L1₀ structure are FePt alloy particles, the Curie temperature of the FePt alloy particles is 750 K, and the Curie temperature of the CoPt alloy particles is 840 K. When the magnetic particles having the L1₀ structure are used in the magnetic layer 40, by setting the gradient of the Curie temperature in the depth direction of the magnetic layer 40 within the range of 0.05 to 1 K/nm, it is possible to reduce the disturbance of the rotation of the magnetic spin in the depth direction of the magnetic layer 40 during laser heating.

This is also true when Ir, Ru or Pd is used instead of Rh as the additive element. That is, when Ir is used as the additive element, the gradient of the Curie temperature in the depth direction of the magnetic layer is within the range of 0.05 to 1 K/nm. When Ru is used as the additive element, the gradient of the Curie temperature in the depth direction of the magnetic layer is within the range of 0.06 to 1.2 K/nm. When Pd is used as the additive element, the gradient of the Curie temperature in the depth direction of the magnetic layer is within the range of 0.02 to 0.4 K/nm. In the case of both elements, it is possible to reduce the disturbance of the rotation of the magnetic spin in the depth direction of the magnetic layer 40 during laser heating.

As described above, the magnetic layer 40 is divided into 3 regions corresponding to the amount of the additive element: a region up to 2.5 nm from the surface where the magnetic layer 40 faces the protective layer 50, a region up to 5 nm from the surface where the magnetic layer 40 faces the second underlying layer 30, and other regions; however, it is not necessary to form the magnetic layer 40 as a 3-layer structure corresponding to the 3 regions. For example, each region of the 3 regions may be formed as a multilayer structure, or all regions of the 3 regions may be formed with a graded composition by gradually changing the amount of the additive element.

The perpendicular thermal conductivity and the planar thermal conductivity of the magnetic particles can be measured by a known method such as a time-domain thermoreflectance (TDTR) method.

The content of the additive element in a region up to 2.5 nm from the surface where the magnetic layer 40 faces the protective layer 50 is 5 atom % or less of the entire content of the magnetic layer 40, preferably 4.8 atom % or less, more preferably 4.6 atom % or less, and more preferably 4.5 atom % or less.

In the present embodiment, the content of the additive element in a region up to 2.5 nm from the surface where the magnetic layer 40 faces the protective layer 50 can be measured using a general analyzer for measuring the content of an element. For example, the content of the additive element can be measured by XPS after etching the magnetic layer 40 in the depth direction thereof. Further, the content of the additive element can be measured by EDS or the like at a corresponding part of a cross section of the magnetic layer 40 observed by TEM.

The content of the additive element in a region up to 5 nm from the surface of the magnetic layer 40 facing the second underlying layer 30 is within the range of 50 to 95 atom % of the entire magnetic layer 40, preferably 53 to 90 atom %, more preferably 55 to 80 atom %, and even more preferably 56 to 70 atom %.

In the present embodiment, the content of the additive element in a region up to 5 nm from the surface of the magnetic layer 40 facing the second underlying layer 30 can be measured by the same method as the content of the additive element in a region up to 2.5 nm from the surface of the magnetic layer 40 facing the protective layer 50.

The thickness of the magnetic layer 40 is within the range of 10 to 25 nm, preferably within the range of 12 to 23 nm, more preferably within the range of 15 to 20 nm, and even more preferably within the range of 16 to 18 nm.

In this specification, the thickness of the magnetic layer 40 means a length in a direction perpendicular to the main surface of the magnetic layer 40. The thickness of the magnetic layer 40 may be, for example, a thickness measured at an arbitrary location in the cross section of the magnetic layer 40, or a thickness measured at several arbitrary locations and an average value of these measured values. Hereinafter, the thickness is defined similarly for other members.

The concentration gradient of the additive element from the surface (lower surface) where the magnetic layer faces the second underlying layer to the surface (upper surface) where the magnetic layer faces the protective layer is preferably 0.60 to 2.50 atom %/nm, more preferably 0.63 to 2.00 atom %/nm, and even more preferably 0.65 to 1.50 atom %/nm. When the concentration gradient of the additive element is 0.60 to 2.50 atom %/nm, disturbance of rotation of magnetic spins in the depth direction of the magnetic layer 40 can be further reduced during laser heating.

The concentration gradient of the additive element can be calculated, for example, by XPS while etching the surface of the magnetic layer 40 in the depth direction.

The magnetic layer 40 includes magnetic particles having an L1₀ structure. Examples of the magnetic particles having an L1₀ structure included in the magnetic layer 40 include FePt alloy particles and CoPt alloy particles. The FePt alloy particles and the CoPt alloy particles are preferably magnetic particles having an L1₀ structure and oriented in the (001) direction. By using such magnetic particles, it is easy to increase the anisotropy of the thermal conductivity in the direction perpendicular to the plane direction by 2 times or more.

Here, when FePt is oriented in the (001) direction with the L1₀ structure, the thermal conductivity in the perpendicular direction is approximately 11.9 W/(m·K), the thermal conductivity in the planar direction is approximately 4.0 W/(m·K), and when CoPt is oriented in the (001) direction with the L1₀ structure, the thermal conductivity in the perpendicular direction is approximately 13.0 W/(m·K), and the thermal conductivity in the planar direction is approximately 4.3 W/(m·K). Note that even if Rh or the like within the range of 0.1 to 2 atom % is added to the magnetic layer, the amount of addition is so small that the thermal conductivity does not appreciably change.

The magnetic particles included in the magnetic layer 40 are preferably columnar crystals having a shape extending through the magnetic layer 40. By forming the magnetic particles in such columnar crystals, it is easy to increase the anisotropy of the thermal conductivity in the perpendicular direction with respect to the planar direction by 2 times or more.

The thermal conductivity in the perpendicular direction of the magnetic particles included in the magnetic layer 40 is within the range of 10 to 20 W/(m·K), preferably 11 to 18 W/(m·K), more preferably 11.5 to 17 W/(m·K), and even more preferably 11.8 to 16 W/(m·K).

The planar thermal conductivity of the magnetic particles contained in the magnetic layer 40 is within the range of 1 to 10 W/(m·K), preferably 2 to 8 W/(m·K), more preferably 3 to 7 W/(m·K), and even more preferably 4 to 6 W/(m·K).

The ratio of the perpendicular thermal conductivity of the magnetic particles contained in the magnetic layer 40 to the planar thermal conductivity indicates the anisotropy of the magnetic particles. The ratio is 2 or greater, preferably 2.2 or greater, more preferably 2.5 or greater, and even more preferably 3.0 or greater.

The first underlying layer 20 preferably contains Ag, Au, Al, Cu, Rh, Mo, or W as a main component. The thermal conductivity of each material is illustrated in Table 1. The thermal conductivity in the case of an alloy can be obtained, for example, by converting the thermal conductivity of each material constituting the alloy by a volume ratio.

TABLE 1

| | THERMAL |
|---|---|
| | CONDUCTIVITY |
| MATERIAL | [W/(m · K)] |
| Ag | 425 |
| Au | 316 |
| Al | 238 |
| Cu | 397 |
| Rh | 148 |
| Mo | 137 |
| W | 174 |

The thickness of the first underlying layer 20 is greater than or equal to 10 nm, preferably greater than or equal to 13 nm, more preferably greater than or equal to 15 nm, and even more preferably greater than or equal to 20 nm. The upper limit value of the thickness of the first underlying layer 20 is not particularly limited, but may be less than or equal to 100 nm, may be less than or equal to 80 nm, or may be less than or equal to than 60 nm.

The average thermal conductivity in a region up to 10 nm from the surface of the first underlying layer 20 facing the magnetic layer 40 is greater than or equal to 100 W/(m·K), preferably greater than or equal to 120 W/(m·K), more preferably greater than or equal to 130 W/(m·K), and even more preferably greater than or equal to 135 W/(m·K). The upper limit value of the average thermal conductivity may be less than or equal to 500 W/(m·K), and may be less than or equal to 450 W/(m·K).

The second underlying layer 30 includes an ionic crystal having a thickness within a range of 0.5 to 15 nm. The second underlying layer 30 preferably includes a NaCl-type compound as the ionic crystal. Examples of the NaCl-type compound include MgO, TiO, NiO, TiN, TaN, HfN, NbN, ZrC, HfC, TaC, NbC, and TiC. One of these may be used alone, or two or more may be used in combination.

As a material constituting the second underlying layer 30, it is particularly preferable to use, in addition to the ionic crystal, a material capable of orienting magnetic particles having an L1₀ structure contained in the magnetic layer 40 in the (001) plane.

The second underlying layer 30 may have a multilayer structure.

The thickness of the ionic crystal is within a range of 0.5 to 15 nm, preferably 1 to 13 nm, more preferably 3 to 12 nm, and even more preferably 5 to 10 nm.

The substrate 10 may be a substrate generally used for the magnetic recording medium 1. A heat-resistant glass substrate having a softening temperature of, for example, 500° C. or higher, preferably 600° C. or higher, is preferably used as the substrate 10. When the magnetic recording medium 1 is manufactured, the heat-resistant glass substrate may be used even when the substrate 10 is heated to a temperature of 500° C. or higher.

Examples of the protective layer 50 include a hard carbon film or the like.

Examples of methods for forming the protective layer 50 include an RF-CVD (Radio Frequency-Chemical Vapor Deposition) method in which a hydrocarbon gas (source gas) is decomposed by a radio frequency plasma to form a film, an IBD (Ion Beam Deposition) method in which a source gas is ionized by electrons emitted from a filament to form a film, and an FCVA (Filtered Cathodic Vacuum Arc) method in which a solid carbon target is used to form a film without using a source gas.

The thickness of the protective layer 50 is preferably 1 to 6 nm. When the thickness of the protective layer 50 is 1 nm or more, the levitation characteristic of the magnetic head is excellent, and when the thickness is 6 nm or less, the magnetic spacing is reduced and the SNR (signal/noise ratio (S/N ratio)) of the magnetic recording medium 1 is improved.

The magnetic recording medium 1 may further include a lubricant layer on the protective layer 50.

The lubricant layer can be formed by using a liquid lubricant layer. A liquid lubricant having chemical stability, low friction, and low adsorption is preferably used. The liquid lubricant includes, for example, a fluororesin lubricant such as a perfluoropolyether lubricant containing a compound having a perfluoropolyether structure.

The thickness of the lubricant layer is not particularly limited, but may be, for example, 1 to 3 nm.

In addition to the first underlying layer 20, the second underlying layer 30, the magnetic layer 40, and the protective layer 50, the magnetic recording medium 1 may include any layers as appropriate. For example, the magnetic recording medium 1 may include an adhesive layer, a soft magnetic underlying layer, and the like between the substrate 10 and the first underlying layer 20 as appropriate. The soft magnetic underlying layer may include, for example, a first soft magnetic layer, an intermediate layer, and a second soft magnetic layer. The material for forming the adhesion layer, the soft magnetic underlying layer, and the like may be a general material used for a magnetic recording medium.

### [Magnetic Storage Device]

A magnetic storage device including a magnetic recording medium according to the present embodiment will be described. The configuration of the magnetic storage device according to the present embodiment is not particularly limited as long as it has the magnetic recording medium according to the present embodiment. Here, a case where the magnetic storage device records magnetic information on the magnetic recording medium by using a heat-assisted recording method will be described.

The magnetic storage device according to the present embodiment may include, for example, a magnetic recording medium driving unit for driving and rotating the magnetic recording medium according to the present embodiment, a magnetic head having a near-field light generating element provided at a tip portion, a magnetic head driving unit for driving and moving the magnetic head, and a recording/reproducing signal processing system.

The magnetic head is a magnetic head of a heat-assisted recording method and includes, for example, a laser light generating unit for generating laser light and heating the magnetic recording medium, and a waveguide for guiding the laser light generated from the laser light generating unit to the near-field light generating element.

FIG. 2 is a perspective view of an example of a magnetic storage device using a magnetic recording medium according to the present embodiment. As illustrated in FIG. 2, a magnetic storage device 100 may include a magnetic recording medium 101, a magnetic recording medium driving unit 102 for rotating the magnetic recording medium 101, a magnetic head 103 having a near-field light generating element at its tip, a magnetic head driving unit 104 for moving the magnetic head 103, and a recording/reproducing signal processing unit 105. The magnetic recording medium 1 described above is used as the magnetic recording medium 101.

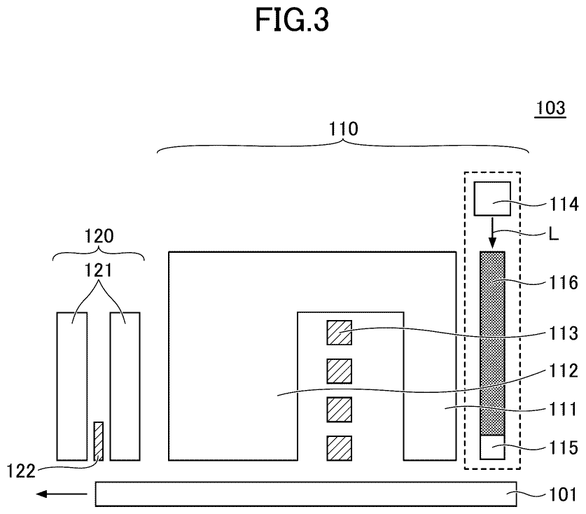

FIG. 3 schematically illustrates an example of the magnetic head 103. As illustrated in FIG. 3, the magnetic head 103 includes a recording head 110 and a read head 120.

The recording head 110 includes a main magnetic pole 111, an auxiliary magnetic pole 112, a coil 113 for generating a magnetic field, a laser diode (LD) 114 for generating a laser beam, and a waveguide 116 for guiding the laser beam L generated from the LD 114 to the near-field light generating element 115.

The read head 120 has shields 121 and a reproducing element 122 sandwiched by the shields 121.

As illustrated in FIG. 3, in the magnetic storage device 100, the central portion of the magnetic recording medium 101 is attached to the rotating shaft of the spindle motor, and information is written to or read from the magnetic recording medium 101 while the magnetic head 103 floats and travels on the surface of the magnetic recording medium 101 rotationally driven by the spindle motor.

In the magnetic storage device 100 according to the present embodiment, by using the magnetic recording medium 1 for the magnetic recording medium 101, the areal recording density of the magnetic recording medium 101 can be increased, and therefore the recording capacity of the magnetic recording medium 101 can be increased.

Although the embodiments have been described as above, the embodiments described above are presented by way of example, and the present disclosure is not limited by the embodiments described above. The embodiments described above can be carried out in various other forms, and various combinations, omissions, substitutions, changes, and the like can be made without departing from the gist of the invention. The embodiments described above and variations thereof are included in the scope and gist of the invention, and are included equally with the inventions described in the claims.

### EXAMPLES

Hereinafter, the present embodiment will be described in more detail by illustrating Examples and Comparative Examples, but the present embodiment is not limited to these Examples and Comparative Examples.

### <Production of Magnetic Recording Medium>

### Example 1

A 50 atom % Cr-50 atom % Ti alloy layer having a thickness of 100 nm and a 63 atom % Co-27 atom % Fe-5 atom % Zr-5 atom % B alloy layer having a thickness of 30 nm were sequentially formed on a glass substrate by a sputtering method as an underlying layer. Next, after heating the glass substrate to 250° C., a Mo layer having a thickness of 40 nm was formed as a first underlying layer and then an MgO layer having a thickness of 5 nm was formed as a second underlying layer by a sputtering method. Next, after heating the glass substrate to 450° C., a 94 atom % FePt-5 atom % Rh-1 atom % BN alloy layer having a thickness of 2 nm was formed as a first magnetic layer and then a 99 atom % FePt-1 atom % BN alloy layer having a thickness of 10 nm was formed as a second magnetic layer by a sputtering method. Next, a carbon film having a thickness of 3 nm was formed as a protective layer to prepare a magnetic recording medium.

Tables 2 to 4 show the configuration (material and thickness) and characteristics (thermal conductivity) of the first underlying layer, the configuration (material and thickness) of the second underlying layer, the configuration (layer structure and thickness) and characteristics (perpendicular thermal conductivity, horizontal thermal conductivity, and anisotropy) of the magnetic layer, and the configuration of the additive elements included in the magnetic layer. The configuration of the additive elements is the material and total content of the additive elements, the content of the additive elements in a region up to 2.5 nm from the surface where the magnetic layer faces the protective layer, the content of the additive elements in a region up to 5 nm from the surface where the magnetic layer faces the second underlying layer, and the concentration gradient of the additive elements.

The thickness of the first underlying layer and the second underlying layer, the thermal conductivity of the first underlying layer, the thermal conductivity in the perpendicular direction, the thermal conductivity in the horizontal direction, and the anisotropy of the magnetic layer, the content of the additive element in a region up to 2.5 nm from the surface (upper surface) where the magnetic layer faces the protective layer, the content of the additive element in a region up to 5 nm from the surface (lower surface) where the magnetic layer faces the second underlying layer, and the concentration gradient of the additive element were measured as follows.

### (Thickness of the First Underlying Layer and the Second Underlying Layer)

The thicknesses of the first underlying layer and the second underlying layer were measured by observing the cross sections of the first underlying layer and the second underlying layer by TEM.

### (Thermal Conductivity of the First Underlying Layer)

The thermal conductivity of the first underlying layer was measured by using the TDTR method.

### (Perpendicular Thermal Conductivity, Horizontal Thermal Conductivity, and Anisotropy of the Magnetic Layer)

The perpendicular and horizontal thermal conductivities of the magnetic layer were measured by using the TDTR method.

The anisotropy of the magnetic layer, which is the ratio of the perpendicular thermal conductivity to the planar thermal conductivity, was calculated by dividing the perpendicular thermal conductivity of the magnetic layer by the planar thermal conductivity of the magnetic layer (perpendicular thermal conductivity/planar thermal conductivity).

(The Content of the Additive Element in a Region Up to 2.5 nm from the Surface (Upper Surface) where the Magnetic Layer Faces the Protective Layer, and the Content of the Additive Element in a Region Up to 5 nm from the Surface (Lower Surface) where the Magnetic Layer Faces the Second Underlying Layer)

The content of the additive element in the region up to 2.5 nm from the upper surface of the magnetic layer and the content of the additive element in the region up to 5 nm from the lower surface of the magnetic layer were measured by XPS.

### (Concentration Gradient of the Additive Element)

The concentration gradient of the additive element was measured by XPS while etching the magnetic layer in the depth direction.

From Table 4, although the content of the additive element in the region up to 2.5 nm from the upper surface of the magnetic layer was less than the content of the additive element in the region up to 5 nm from the lower surface of the magnetic layer, the additive element was observed even though the second magnetic layer was formed with the configuration illustrated in Table 3. Therefore, it was confirmed that the additive element in the magnetic layer diffused from the lower surface to the upper surface of the magnetic layer.

### Examples 2 to 13, Comparative Examples 1 to 8

A magnetic recording medium was prepared in the same manner as in Example 1 except that the configuration (material and thickness) and characteristics (thermal conductivity) of the first underlying layer, the configuration (material and thickness) of the second underlying layer, the configuration (layer structure and thickness) and characteristics (perpendicular thermal conductivity, horizontal thermal conductivity and anisotropy) of the magnetic layer, and the configuration of the additive element included in the magnetic layer were changed to the conditions illustrated in Tables 2 to 4. Note that the underlined values in Table 2 to 4 indicate values outside the range of the present embodiment.

### <Evaluation of Electromagnetic Conversion Characteristics (SNR) of Magnetic Recording Medium>

The electromagnetic conversion characteristics (SNR) of the magnetic recording medium manufactured in each Example and each Comparative Example were evaluated by using a spin stand manufactured by Guzik Technical Enterprises. The evaluation results are illustrated in Table 4.

TABLE 2

| | FIRST UNDERLYING LAYER | | | | |
|---|---|---|---|---|---|
| | | | THERMAL | SECOND UNDERLYING LAYER | |
| | | THICKNESS | CONDUCTIVITY | | THICKNESS |
| | MATERIAL | [nm] | [W/(m · K)] | MATERIAL | [nm] |
| EXAMPLE 1 | Mo | 40 | 137 | MgO | 5 |
| EXAMPLE 2 | Mo | 40 | 137 | MgO | 5 |
| EXAMPLE 4 | Ag | 13 | 425 | MgO | 5 |
| EXAMPLE 5 | Mo | 60 | 137 | MgO | 5 |
| EXAMPLE 6 | Mo | 40 | 137 | MgO | 5 |
| EXAMPLE 7 | Mo | 40 | 137 | MgO | 5 |
| EXAMPLE 8 | Mo | 40 | 137 | MgO | 5 |
| EXAMPLE 9 | W | 40 | 174 | MgO | 5 |
| EXAMPLE 10 | Cu | 15 | 397 | MgO | 5 |
| EXAMPLE 11 | Mo | 40 | 137 | MgO | 5 |
| EXAMPLE 12 | Mo | 40 | 137 | MgO | 5 |
| EXAMPLE 13 | Mo | 40 | 137 | MgO | 5 |
| COMPARATIVE | Mo | 40 | 137 | MgO | 5 |
| EXAMPLE 1 | | | | | |
| COMPARATIVE | Mo | 40 | 137 | MgO | 5 |
| EXAMPLE 2 | | | | | |
| COMPARATIVE | Mo | 40 | 137 | MgO | 5 |
| EXAMPLE 3 | | | | | |
| COMPARATIVE | Mo | 40 | 137 | MgO | 20 |
| EXAMPLE 4 | | | | | |
| COMPARATIVE | Ag | 13 | 425 | MgO | 5 |
| EXAMPLE 5 | | | | | |
| COMPARATIVE | Mo | 10 | 137 | MgO | 5 |
| EXAMPLE 6 | | | | | |
| COMPARATIVE | Mo | 40 | 137 | MgO | 5 |
| EXAMPLE 7 | | | | | |
| COMPARATIVE | Mo | 40 | 137 | MgO | 5 |
| EXAMPLE 8 | | | | | |

TABLE 3

| | MAGNETIC LAYER | | | | |
|---|---|---|---|---|---|
| | LAYER STRUCTURE | | THERMAL | THERMAL | |
| | (SECOND MAGNETIC LAYER/ | | CONDUCTIVITY IN | CONDUCTIVITY | |
| | FIRST MAGNETIC LAYER) | THICK- | PERPENDICULAR | IN PLANAR | |
| | (VALUE IN PARENTHESIS | NESS | DIRECTION | DIRECTION | ANISOT- |
| | INDICATES THICKNESS.) | [nm] | [W/(m · K)] | [W/(m · K)] | ROPY |
| EXAMPLE 1 | FePt—BN(10 nm)/FePt—5Rh—BN(2 nm) | 12 | 11.9 | 4.0 | 3.0 |
| EXAMPLE 2 | FePt—BN(10 nm)/FePt—10Rh—BN(2 nm) | 12 | 11.9 | 4.0 | 3.0 |
| EXAMPLE 4 | FePt—BN(10 nm)/FePt—5Rh—BN(2 nm) | 12 | 11.9 | 4.0 | 3.0 |
| EXAMPLE 5 | FePt—BN(10 nm)/FePt—5Rh—BN(2 nm) | 12 | 11.9 | 4.0 | 3.0 |
| EXAMPLE 6 | FePt—BN(13 nm)/FePt—5Rh—BN(2 nm) | 15 | 11.9 | 4.0 | 3.0 |
| EXAMPLE 7 | FePt—BN(16 nm)/FePt—5Rh—BN(2 nm) | 18 | 11.9 | 4.0 | 3.0 |
| EXAMPLE 8 | FePt—BN(16 nm)/FePt—10Rh—BN(2 nm) | 18 | 11.9 | 4.0 | 3.0 |
| EXAMPLE 9 | FePt—BN(10 nm)/FePt—5Rh—BN(2 nm) | 12 | 11.9 | 4.0 | 3.0 |
| EXAMPLE 10 | FePt—BN(10 nm)/FePt—5Rh—BN(2 nm) | 12 | 11.9 | 4.0 | 3.0 |
| EXAMPLE 11 | FePt—BN(10 nm)/FePt—5Ir—BN(2 nm) | 12 | 11.9 | 4.0 | 3.0 |
| EXAMPLE 12 | FePt—BN(10 nm)/FePt—5Ru—BN(2 nm) | 12 | 11.9 | 4.0 | 3.0 |
| EXAMPLE 13 | FePt—BN(10 nm)/FePt—5Pd—BN(2 nm) | 12 | 11.9 | 4.0 | 3.0 |
| COMPARATIVE | FePt—BN(10 nm)/FePt—BN(2 nm) | 12 | 11.9 | 4.0 | 3.0 |
| EXAMPLE 1 | | | | | |
| COMPARATIVE | FePt—BN(10 nm)/FePt—5Rh—BN(2 nm) | 12 | 11.9 | 4.0 | 3.0 |
| EXAMPLE 2 | | | | | |
| COMPARATIVE | FePt—BN(10 nm)/FePt—5Rh—BN(2 nm) | 12 | 11.9 | 4.0 | 3.0 |
| EXAMPLE 3 | | | | | |
| COMPARATIVE | FePt—BN(10 nm)/FePt—5Rh—BN(2 nm) | 12 | 11.9 | 4.0 | 3.0 |
| EXAMPLE 4 | | | | | |
| COMPARATIVE | FePt—BN(10 nm)/FePt—5Rh—BN(2 nm) | 12 | 11.9 | 4.0 | 3.0 |
| EXAMPLE 5 | | | | | |
| COMPARATIVE | FePt—BN(10 nm)/FePt—10Rh—BN(2 nm) | 12 | 11.9 | 4.0 | 3.0 |
| EXAMPLE 6 | | | | | |
| COMPARATIVE | FePt—BN(10 nm)/FePt—20Rh—BN(2 nm) | 12 | 11.9 | 4.0 | 3.0 |
| EXAMPLE 7 | | | | | |
| COMPARATIVE | FePt—BN(10 nm)/FePt—2Rh—BN(2 nm) | 12 | 11.9 | 4.0 | 3.0 |
| EXAMPLE 8 | | | | | |

TABLE 4

| | ADDITIVE ELEMENT TO MAGNETIC LAYER | | | | | |
|---|---|---|---|---|---|---|
| | | | REGION 2.5 nm | REGION 5 nm | | |
| | | | FROM SURFACE | FROM SURFACE | | |
| | | | (UPPER SURFACE) | (LOWER SURFACE) | | |
| | | | WHERE MAGNETIC | WHERE MAGNETIC | DENSITY | |
| | | | LAYER FACES | LAYER FACES | GRADIENT OF | MAGNETIC |
| | | TOTAL | PROTECTIVE | SECOND | ADDITIVE | RECORDING MEDIUM |
| | MATE- | CONTENT | LAYER | UNDERLYING | ELEMENT | SNR |
| | RIAL | [ATOM %] | [ATOM %] | LAYER [ATOM %] | [ATOM %/nm] | [dB] |
| EXAMPLE 1 | Rh | 0.83 | 4.6 | 57 | 0.67 | 11.6 |
| EXAMPLE 2 | Rh | 1.67 | 4.7 | 58 | 1.34 | 10.5 |
| EXAMPLE 4 | Rh | 0.83 | 4.8 | 57 | 0.67 | 10.9 |
| EXAMPLE 5 | Rh | 0.83 | 4.6 | 57 | 0.67 | 11.4 |
| EXAMPLE 6 | Rh | 0.83 | 4.2 | 56 | 0.67 | 11.8 |
| EXAMPLE 7 | Rh | 0.83 | 3.9 | 56 | 0.67 | 11.2 |
| EXAMPLE 8 | Rh | 1.67 | 3.6 | 58 | 1.34 | 11.4 |
| EXAMPLE 9 | Rh | 0.83 | 4.6 | 57 | 0.67 | 11.2 |
| EXAMPLE 10 | Rh | 0.83 | 4.6 | 57 | 0.67 | 11.0 |
| EXAMPLE 11 | Ir | 0.83 | 4.8 | 55 | 0.69 | 11.8 |
| EXAMPLE 12 | Ru | 0.83 | 4.4 | 60 | 0.71 | 11.5 |
| EXAMPLE 13 | Pd | 0.83 | 4.7 | 56 | 0.65 | 11 |
| COMPARATIVE | NONE | 0 | 0 | 0 | — | 7.9 |
| EXAMPLE 1 | | | | | | |
| COMPARATIVE | Rh | 0.83 | 9.3 | 31 | 0.50 | 9.8 |
| EXAMPLE 2 | | | | | | |
| COMPARATIVE | Rh | 0.83 | 0 | 100 | ∞ | 9.5 |
| EXAMPLE 3 | | | | | | |
| COMPARATIVE | Rh | 0.83 | 4.6 | 57 | 0.67 | 9.2 |
| EXAMPLE 4 | | | | | | |
| COMPARATIVE | Rh | 0.83 | 9.5 | 31 | 0.48 | 9.7 |
| EXAMPLE 5 | | | | | | |
| COMPARATIVE | Rh | 1.67 | 4.7 | 58 | 1.34 | 8.3 |
| EXAMPLE 6 | | | | | | |
| COMPARATIVE | Rh | 3.34 | 4.6 | 57 | 2.68 | 9.00 |
| EXAMPLE 7 | | | | | | |
| COMPARATIVE | Rh | 0.33 | 4.7 | 58 | 0.27 | 8.4 |
| EXAMPLE 8 | | | | | | |

From Table 2 to 4, it was confirmed that the SNR of the magnetic recording medium of each Example was 10.5 dB or more, the SNR of the magnetic recording medium of each Comparative Example was 9.8 dB or less, and that the magnetic recording medium of each Example could exhibit a higher SNR than the magnetic recording medium of each Comparative Example even if the magnetic layer was thickened to 12 nm or more.

Therefore, it has been confirmed that the magnetic recording medium according to the present embodiment can improve electromagnetic conversion characteristics even when used in a heat-assisted recording system. Therefore, because the magnetic recording medium according to the present embodiment has a high areal recording density when used as a heat-assisted magnetic recording medium, it can be said that it can have a high recording capacity when used in a magnetic storage device.

According to one aspect of the present disclosure, it is possible to provide a magnetic recording medium that can improve electromagnetic conversion characteristics even when used in a heat-assisted recording system.

According to an aspect of the present disclosure, it is possible to provide a magnetic storage device having an increased recording capacity by using a magnetic recording medium that can improve electromagnetic conversion characteristics even when used in a heat-assisted recording system.

What is claimed is:

1. A magnetic recording medium of a heat-assisted recording system, the magnetic recording medium comprising:
a substrate;
a first underlying layer;
a second underlying layer;
a magnetic layer; and
a protective layer, which are stacked in an order of the substrate followed by the first underlying layer followed by the second underlying layer followed by the magnetic layer followed by the protective layer, wherein
a thickness of the magnetic layer is within a range of 10 nm to 25 nm,
the magnetic layer includes magnetic particles having an L1₀ structure,
a thermal conductivity of the magnetic particles in a perpendicular direction of the magnetic layer is within a range of 10 W/(m·K) to 20 W/(m·K), a thermal conductivity of the magnetic particles in a planar direction of the magnetic layer is within a range of 1 W/(m·K) to 10 W/(m·K), and a ratio of the thermal conductivity in the perpendicular direction to the thermal conductivity in the planar direction is 2 or greater,
the magnetic layer includes, as an additive element, at least one element selected from a group consisting of Rh, Ir, Ru, and Pd,
an additive amount of the additive element is within a range of 0.1 atom % to 2 atom % of a total amount of the magnetic layer,
a content of the additive element in a region up to 2.5 nm from a surface of the magnetic layer facing the protective layer is 5 atom % or less of the total amount of the magnetic layer,
a content of the additive element in a region up to 5 nm from a surface of the magnetic layer facing the second underlying layer is within a range of 50 atom % to 95 atom % of the total amount of the magnetic layer,
a thickness of the first underlying layer is 10 nm or more,
an average thermal conductivity in a region up to 10 nm from a surface of the first underlying layer facing the magnetic layer is 100 W/(m·K) or more, and
the second underlying layer includes an ionic crystal having a thickness within a range of 0.5 nm to 15 nm.

2. The magnetic recording medium according to claim 1, wherein the magnetic particles having the L1₀ structure included in the magnetic layer are FePt alloy particles.

3. The magnetic recording medium according to claim 1, wherein the ionic crystal is MgO.

4. A magnetic storage device comprising:
the magnetic recording medium according to claim 1.
